(19) United States
(12) Patent Application Publication
(10) Pub. No.: US 2008/0219303 A1
(43) Pub. Date: Sep. 11, 2008

(54) Color mixing light source and color control data system

(75) Inventors: Gang Chen, Basking Ridge, NJ (US); Ronen Rapaport, Millburn, NJ (US); Michael J. Schabel, Clark, NJ (US)

Correspondence Address: Jay M. Brown, 6409 Fayetteville Road, Suite 120-306, Durham, NC, 27713, US

(73) Assignee: Lucent Technologies Inc., Murray Hill, NJ (US)

(21) Appl. No.: 11/713,483

(22) Filed: Mar. 2, 2007

(51) Int. Cl. H01S 3/10

(52) U.S. Cl. 372/23

(57) ABSTRACT

Apparatus including a color mixing light source having a first laser configured to lase at one or a plurality of light emission wavelengths of 459 nanometers or less and a second laser configured to lase at one or a plurality of light emission wavelengths of 470 nanometers or more; and a controller having a color control data input and a color control data output configured to cause the color mixing light source to generate a perceptual mixture of light having a perceptual color, the perceptual mixture including light emissions from the first and second light sources. System configured to map first color control data to second color control data. Method of forming a perceptual mixture of light having a perceptual color. Method of converting color control data.

### BACKGROUND OF THE INVENTION

1. Field of the Invention

This invention generally relates to color mixing light sources capable of generating light emissions at multiple wavelengths having a selectable perceptual color, and to color control data systems for such light sources.

2. Related Art

Various types of color mixing light sources have been developed. Examples of such sources have included (i) cathode ray tubes having interior screens printed with matrices of pixels each including one of three different phosphors capable of emitting light, the pixels having three different corresponding perceptual colors when bombarded by a scanning electron beam, (ii) light sources that pass white light through a color wheel with rapid controlled repositioning of the wheel for perceptual color selection, and (iii) liquid crystal displays. Systems have also been developed for generating color control data used in operating such color mixing light sources. There is a continuing need for new types of color mixing light sources capable of generating a perceptual mixture of light at multiple wavelengths having a selectable perceptual color, and systems for generating color control data for such light sources.

### SUMMARY

In an example of an implementation, an apparatus is provided, including a color mixing light source having a first laser configured to lase at one or a plurality of light emission wavelengths of 459 nanometers or less and a second laser configured to lase at one or a plurality of light emission wavelengths of 470 nanometers or more; and a controller having a color control data input, and a color control data output configured to cause the color mixing light source to generate a perceptual mixture of light having a perceptual color, the perceptual mixture including light emissions from the first and second light sources.

As another example of an implementation, a method is provided, including: outputting light from a first light source emitting light at one or a plurality of first light emission wavelengths of 459 nanometers or less, and outputting light from a second light source emitting light at one or a plurality of second light emission wavelengths of 470 nanometers or more; and forming a perceptual mixture of light having a perceptual color, the perceptual mixture including light emissions from the first and second light sources. The method may also include, for example, outputting light from a third light source emitting light at one or a plurality of third light emission wavelengths of 470 nanometers or more where a third wavelength is different than a second wavelength, and forming a perceptual mixture of light having a perceptual color, the perceptual mixture including light emissions from the first, second and third light sources.

A system is provided in a further example of an implementation, including: first color control data conforming to a first perceptual color space; second color control data conforming to a second perceptual color space; and a digital data processor configured to map the first color control data to the second color control data.

As an additional example of an implementation, a method is provided, including: receiving color control data conforming to a first perceptual color space, and identifying the first perceptual color space; accessing color control data defining a second perceptual color space; mapping the first perceptual color space into the second perceptual color space; and converting the received color control data conforming to the first perceptual color space into color control data conforming to the second perceptual color space.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a schematic view showing an example of an implementation of an apparatus.

FIG. 2 is a plot of laser power input levels vs. a range of light emission wavelengths.

FIG. 3 is a plot overlay juxtaposing a graph showing light emission wavelengths that may be generated by selected lasers, together with examples of conventional perceptual color spaces.

FIG. 4 is another plot overlay juxtaposing a graph showing light emission wavelengths that may be generated by selected lasers, together with examples of conventional perceptual color spaces.

FIG. 5 is a flow chart showing an example of an implementation of a method.

FIG. 6 is a schematic view showing an example of an implementation of a system.

FIG. 7 is another flow chart showing an example of an implementation of a method.

### DETAILED DESCRIPTION

An apparatus is provided that includes a color mixing light source having a first laser configured to lase at one or a plurality of light emission wavelengths of 459 nanometers or less. The color mixing light source further has a second laser configured to lase at one or a plurality of light emission wavelengths of 470 nanometers or more. The apparatus also includes a controller that has a color control data input and a color control data output. The color control data output is configured to cause the color mixing light source to generate a perceptual mixture of light having a perceptual color, the perceptual mixture including light emissions from the first and second light sources. As an example, the controller may be configured to receive color control data conforming to a first perceptual color space at the color control data input and to transmit color control data conforming to a second perceptual color space at the color control data output.

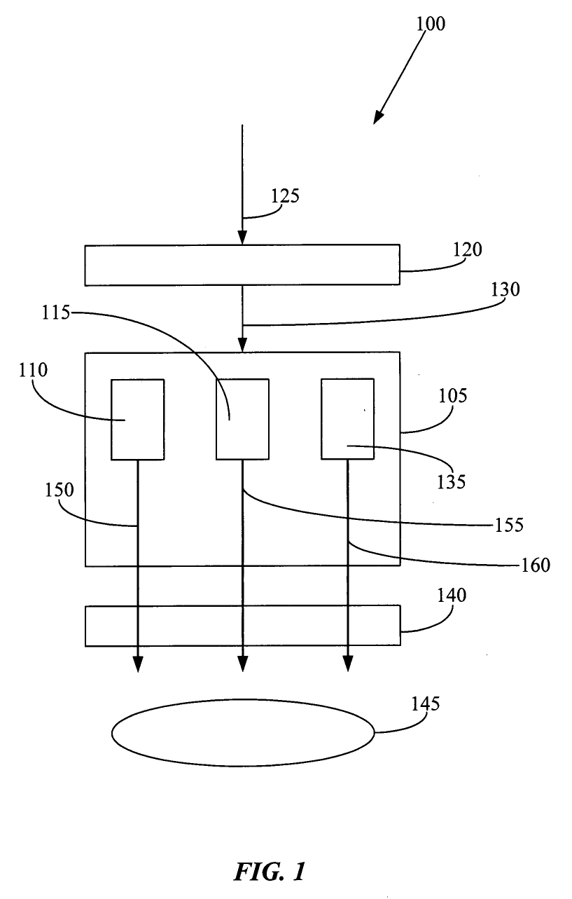

FIG. 1 is a schematic view showing an example of an implementation of an apparatus 100. The apparatus 100 has a color mixing light source 105 including a first laser 110 configured to lase at one or a plurality of light emission wavelengths of 459 nanometers or less. The color mixing light source 105 further includes a second laser 115 configured to lase at one or a plurality of light emission wavelengths of 470 nanometers or more. The apparatus 100 additionally includes a controller 120 having a color control data input 125, and a color control data output 130 in signal communication with the color mixing light source 105. The color mixing light source 105 may, for example, also include a third laser 135, configured to lase at one or a plurality of light emission wavelengths of 470 nanometers or more. Each of the first, second and third lasers 110, 115, 135 may, for example, be configured to lase at different wavelengths.

The controller 120 may, in an example, activate on/off switches (not shown) independently integrated with the lasers 110, 115 and 135. The color control data output 130 is configured to cause the color mixing light source 105 to generate a perceptual mixture of light 140 including light emissions from the first and second lasers 110, 115, and that may also include light emissions from the third laser 135. The perceptual mixture of light 140 has a perceptual color. The perceptual mixture of light 140, including light emissions from two or more of the first, second and third lasers 110, 115, 135 may, for example, be focused into an image spot 145. A perceptual color is a color as perceived by human eyesight. Color vision depends on the interaction of three types of cone cells in the human eye, each of which is sensitive to light in one of three sectors of the spectrum spanning different wavelength ranges. These three sectors of the spectrum are known as blue, green, and red colors. In another example (not shown) light emitted by two or more of the lasers 110, 115, 135 may independently be redirected by a mirror, mirror array, optical grating, lens, or other suitable device (not shown) to form the image spot 145 having a perceptual color. Light emitted from the laser 110 having a wavelength of less than 405 nanometers may, for example, have a dimly perceived or imperceptible color by human eyesight. In an example, the laser 110 may be configured to lase at one or a plurality of wavelengths within a range of between 405 nanometers to 459 nanometers.

In another example, the perceptual mixture of light 140 may include light emissions that are simultaneously emitted from two or more of the first, second and third lasers 110, 115, 135 and may include light emissions at the same or different wavelengths from additional lasers (not shown). The arrows 150, 155, 160 respectively represent light emissions from the first, second and third lasers 110, 115, 135. Simultaneous light emissions represented by the arrows 150, 155, 160 from two or more of the first, second and third lasers 110, 115, 135 may, for example, be focused into an image spot 145 having a perceptual color.

As another example, the perceptual mixture 140 may include light emissions that are sequentially emitted at different points in time from two or more of the first, second and third lasers 110, 115, 135. For example, such sequential emissions may be controlled to conform to a temporal sequence suitable for generating a selected perceptual color. As examples, sequential light emissions from the first and second, first and third, second and third, or all of the first, second and third lasers 110, 115, 135 may be perceived by human eyesight as having a color that is different than a perceptual color of light emissions from any one of the lasers 110, 115, 135 alone. Such sequential light emissions from two or more lasers 110, 115, 135 may, for example, generate a perceptual color that is dependent on various factors including lengths of light emission pulses and a frequency of successive temporal cycling of light emissions from the lasers 110, 115, 135, and including relative intensities of the light emissions from each of the lasers 110, 115, 135. Successive temporal cycling of light emissions as represented by the arrows 150, 155, 160 from two or more lasers 110, 115, 135 at a frequency rate within a range of between about 20 cycles per second to about 30 cycles per second, as an example, may be perceived by human eyesight as if the light emissions were simultaneous. In another example, the first, second and third lasers 110, 115, 135 may respectively emit light at selected wavelengths having perceptual blue, green and red colors. In that example, the perceptual blue, green and red colors may be selected as primaries for utilization in generating a matrix of perceptual mixtures of light having a corresponding spectrum of perceptual colors. Varying the respective intensities of such perceptual blue, green and red colors in forming perceptual mixtures of light may, for example, facilitate generation of a broad range of perceptual colors.

It is understood by those skilled in the art that perceptual light mixtures, whether simultaneous or successively temporally cycled at a selected frequency, may be generated utilizing light emissions from two or more of the first, second and third lasers 110, 115, 135 and may for example include light emissions at the same or different wavelengths from additional lasers (not shown). It is further understood by those skilled in the art that non-simultaneous emissions of laser light from two or more lasers 110, 115, 135 other than the successive temporal cycling explained above may also be utilized.

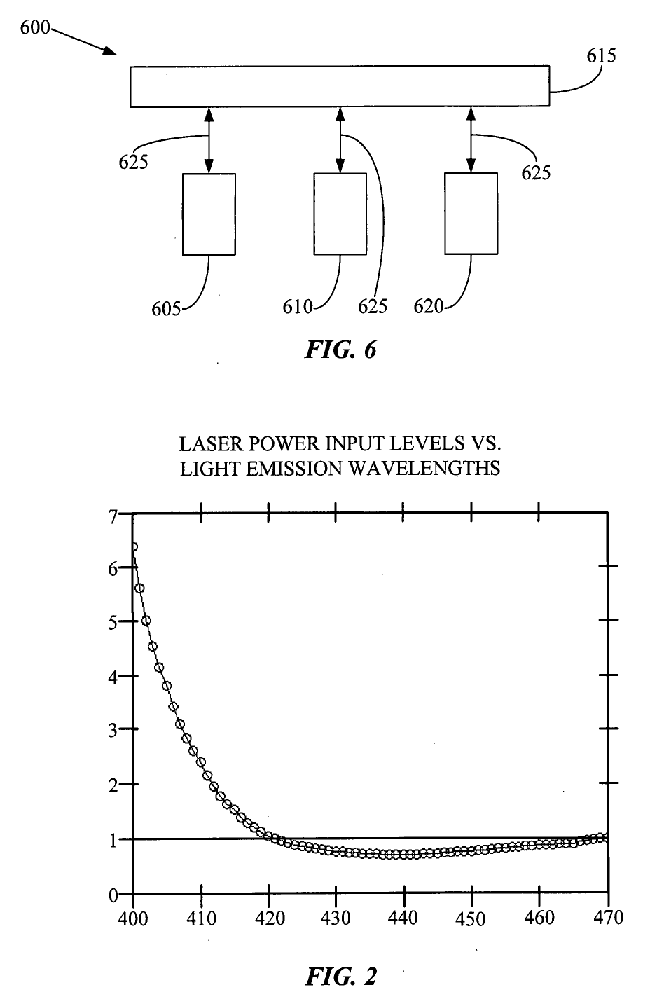

FIG. 2 is a plot of laser power input levels versus light emission wavelengths for selected lasers 110 within a range of between 400 nanometers to 470 nanometers. Light emissions from the laser 110 at a wavelength within a range of between 400 nanometers to 470 nanometers may, for example, be perceived as being blue. In combination with lasers 115, 135 having light emissions perceived as being red and green, the lasers 110 may for example be utilized to produce a perceptual mixture 140 of light perceived by a human eye as being white, defined for example by Commission Internationale d'Eclairage (“CIE”) standards. The x-axis in FIG. 2 plots wavelengths of light emitted by selected lasers 110, within a range of between 400 nanometers to 470 nanometers. The y-axis plots a relative output radiance on a scale within a range of between 0 to 7 of such light emissions from a laser 110 at a selected wavelength within a range of between 400 nanometers to 470 nanometers, that may be needed to produce light having a perceptual white color when combined with light emissions themselves perceptually having green and red colors. This relative output radiance expresses a qualitative light intensity as perceived by human eyesight when light emitted by a laser 110 at a given wavelength is observed as reflected obliquely off a light-scattering white surface.

FIG. 2 illustrates, for example, that relatively stable perceptual radiance levels of light emissions from a laser 110 at lasing wavelengths within a range of between 420 nanometers to 459 nanometers, may be sufficient for combination with light emissions themselves perceptually having green and red colors, to form a perceptual mixture 140 of light having a perceptual white color. As a result, a relatively stable input power level may be utilized for operating a laser 110 at an output lasing wavelength within a range of between 420 nanometers to 459 nanometers as part of the apparatus 100. FIG. 2 further illustrates, for example, that the radiance levels of light emission from a laser 110 that may be needed at lasing wavelengths of less than 420 nanometers for mixing with light emissions themselves perceptually having green and red colors to achieve the same perceptual white color emission, rise in a steeply progressive manner ranging down to 400 nanometers. Utilizing such high intensity light emissions at a wavelength of less than 420 nanometers from the laser 110 may, as examples, require delivery of an impractically high and hazardous power input to the laser 110, and may also involve tolerating a high risk of inadvertent damage to eyesight of an operator of the apparatus 100. As an example, a laser light emission wavelength of at least 420 nanometers may be selected and the laser 110 accordingly may be configured to lase at one or a plurality of wavelengths within a range of between 420 nanometers to 459 nanometers. FIG. 2 further shows that needed input power levels for the laser 110 may gradually escalate at wavelengths above about 445 nanometers. In a further example, the laser 110 may be configured to lase at one or a plurality of wavelengths within a range of between 420 nanometers to 445 nanometers.

The laser 110 may include, for example, a Group III-nitride laser. Such lasers may be commercially available, as examples, from: (i) Nichia America Corporation, 3775 Hempland Road, Mountville, Pa. 17554; (ii) Sanyo North America Corporation, 2055 Sanyo Avenue, San Diego, Calif. 92154; (iii) Mitsubishi Electric and Electronics USA Inc., 5665 Plaza Drive, Cypress, Calif. 90630; or (iv) Opnext (Hitachi), 1 Christopher Way, Eatontown, N.J. 07724. As examples, commercially-available Nichia America Corporation lasers 110 having the following trade designations may be utilized: NDHV310APC, having a lasing emission wavelength of 405 nanometers; and NDHB510APAE1, having a lasing emission wavelength of 445 nanometers. In another example, a commercially-available Sanyo North America Corporation laser 110 having the trade designation DL-6146-301 may be utilized, having a lasing emission wavelength of 405 nanometers. Group III-nitride lasers and methods for their fabrication are disclosed, as an example, in the Razeghi U.S. Pat. No. 5,834,331 issued on Nov. 10, 1998 and titled “Method for Making III-Nitride Laser and Detection Device”. In another example, the laser 110 may include a Group III-nitride quantum well laser. Group III-nitride quantum well lasers and methods for their fabrication are disclosed, as an example, in the Kneissl et al. U.S. Pat. No. 7,138,648 issued on Nov. 21, 2006 and titled “Ultraviolet Group III-Nitride-Based Quantum Well Laser Diodes”. The entireties of each of these two patents are incorporated by reference in this patent application. Where the laser 110 includes a quantum well laser, a separate confinement heterostructure (“SCH”) quantum well laser may, for example, be utilized. The laser 110 may also, as an example, have a distributed feedback structure configured to a selected lasing emission wavelength.

As a further example, the laser 110 may include a wavelength-converted infrared laser. A wavelength-converted infrared laser 110 may, for example, be selected to have an internal or external operating wavelength which after internal or external doubling, tripling, or other wavelength conversion processes, generates output lasing light at a selected wavelength within a range of between 405 to 459 nanometers.

In an example, each of the first, second and third lasers 110, 115, 135 in the apparatus 100 may be configured to lase at different wavelengths. In another example, the second laser 115 may be selected as configured to lase at a wavelength of about 532 nanometers, and the third laser 135 may be selected as configured to lase at a wavelength of about 630 nanometers. For example, the first, second and third lasers 110, 115 and 135 may respectively generate light emissions having perceptual blue, green and red colors. Light within a wavelength range of between 405 nanometers to 470 nanometers may have a perceptually blue color, for example. Light having a wavelength of more than 470 nanometers, such as a wavelength of 532 nanometers or 630 nanometers, may have a different perceptual color such as green or red. In an additional example, light within a wavelength range of between about 500 nanometers to about 565 nanometers may have a perceptually green color. As another example, light within a wavelength range of between about 625 nanometers to about 725 nanometers may have a perceptually red color. It is understood by those skilled in the art that second and third lasers 115, 135 generating light emissions at other wavelengths may be utilized. Further, it is understood that some perceptual colors may be generated by combining together light emissions from only two of the first, second and third lasers 110, 115, 135, or by combining together light emissions from more than three lasers (not shown).

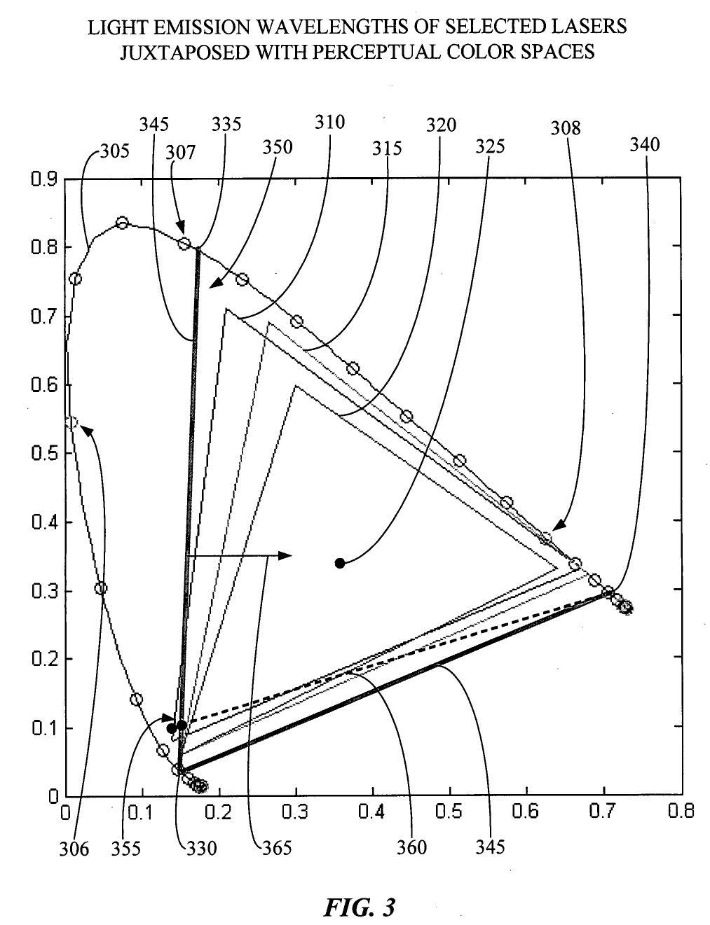

FIG. 3 is a plot overlay including a graph 305 showing light emission wavelengths that may be generated by selected first lasers 110 emitting light at a wavelength that may be within a range of between 405 to 459 nanometers (blue), that may be utilized in an apparatus 100 together with light emissions from second and third light sources 115, 135 at respective emission wavelengths of 532 nanometers (green) and 630 nanometers (red). The graph 305 has circles marking emission wavelengths for the first laser 110 in ten nanometer increments, including circles 306, 307 and 308 respectively indicating 500, 530 and 600 nanometers. The graph 305 is juxtaposed on examples of conventional perceptual color spaces 310, 315, 320 that may be identified by designations respectively including: the National Television System Committee (“NTSC”), Digital Cinema Initiatives (“DCI”), and the International Electro-technical Commission (“IEC”). As to the conventional perceptual color spaces 310, 315, 320, the horizontal x-axis plots relative levels of stimulus (“x”) of red cone cell receptors of a human eye on an intensity scale within a range of between 0 to 0.8. Further as to the conventional perceptual color spaces 310, 315, 320, the vertical y-axis plots relative levels of stimulus (“y”) of green cone cell receptors of a human eye on an intensity scale within a range of between 0 to 0.9. The plotted perceptual color spaces 310, 315, 320 embody normalized light emissions (not themselves plotted in FIG. 3) from a first light source 110 at wavelengths within a range of between 405 nanometers to 459 nanometers having a perceptual blue color. Accordingly, as to the plotted perceptual color spaces 310, 315, 320, a level of stimulus (“z”) of blue cone cell receptors of a human eye is normalized to values of: z=1−(x+y). These stimulus levels x, y, z each express a qualitative level of perceptual intensity of light emitted respectively by the first, second and third light sources 110, 115, 135 that may, for example, together form a perceptual mixture of light 140 having a given perceptual color within the perceptual color spaces 310, 315, 320. As an example, a given point 325 within the perceptual color spaces 310, 315, 320 represents a specific combination of stimulus levels x, y, z of light emissions from the first, second and third light sources 110, 115, 135 that together may be utilized to form a specific perceptual mixture of light 140 having a specific perceptual color within the perceptual color spaces 310, 315, 320.

It is understood by those skilled in the art that the first, second, and third light sources 110, 115, 135 may be utilized, for example, as primes for generating a perceptual color space 310, 315, 320. The perceptual color of a monochromatic light source, such as a first laser 110 configured to emit light at a single one of various wavelengths, is represented by a point on the curve 305. The combination of such points representing all possible monochromatic light sources 110 in the visible spectral range gives the curve 305. A light source 110 may not necessarily be monochromatic, in which case the perceptual color of such a light source 110 is represented by a point inside the space circumscribed by the curve 305. Three multi-chromatic light sources 110, 115, 135 serving as primes and represented by three points (not shown) inside perceptual color space 310, for example, may together form a triangle (not shown) whose area covers a perceptual color sub-space that may be generated by the three primes. As another example, primes having other wavelengths may be utilized.

The graph 305 shows various operating emission wavelengths that may, for example, be selected for the first (blue) light source 110. For example, a laser 110 may be selected for utilization as the first light source, having an operating emission wavelength of 459 nanometers as indicated by the point 330. In the same example, lasers 115 and 135 may be selected to emit light at 532 nanometers and 630 nanometers, respectively represented by points 335 and 340. The boundary lines 345 together with a line (not shown) ending at the points 335, 340 then define a perceptual color space 350 that may be generated, as an example, utilizing lasers 110, 115, 135 having operating emission wavelengths of 459, 532 and 630 nanometers, respectively. Where the perceptual color space 350 is generated, a part 355 of the NTSC perceptual color space 310 may be excluded, for example. The part 355 of the NTSC perceptual color space 310 that may be so excluded from generation where a laser 110 is utilized having an operating emission wavelength of 459 nanometers, may represent perceptual colors that cannot be generated by combining together light emissions from the three color sources 110, 115, 135. However, the part 355 may represent a small portion of the perceptual color space 310 that cannot be generated utilizing such a laser 110 as the first color source. In addition, the conventional perceptual color spaces 310, 315, 320 may include color control data for generating some perceptual mixtures of light 140 that cannot be perceived by the human eye. Further, contrast between different mixtures of light 140 as perceived by the human eye may be more important, in determining the quality of an image as perceived, than duplicating all possible perceptual colors. Likewise, small parts of the perceptual color spaces 315, 320 may be excluded from generation by utilizing the three color sources 110, 115, 135 including such a laser 110 as the first color source.

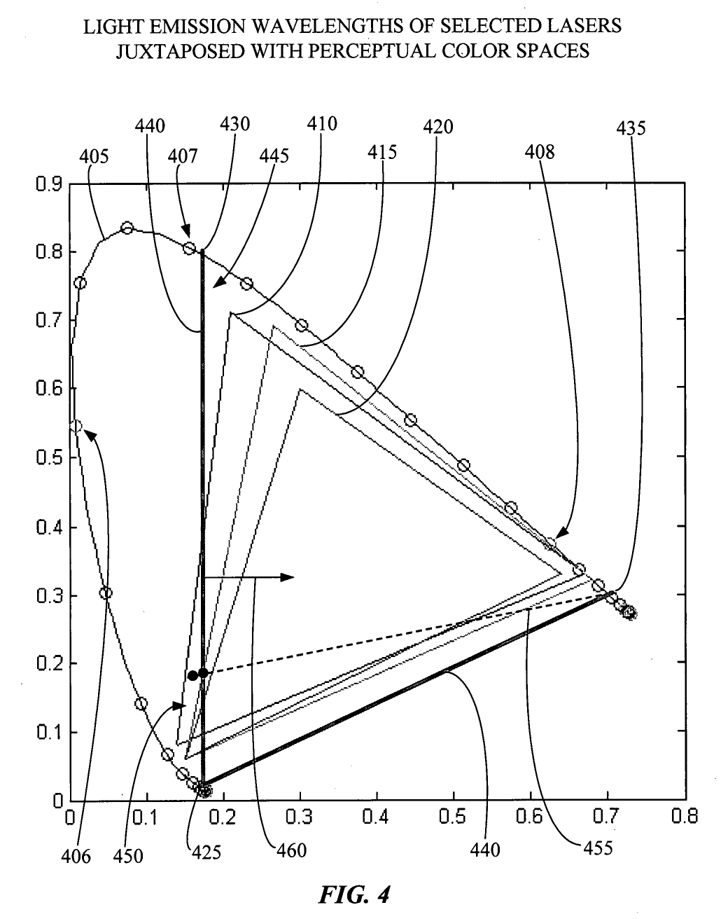

FIG. 4 is another plot overlay including a graph 405 showing light emission wavelengths that may be generated by selected first lasers 110 emitting light at a wavelength that may be within a range of between 405 to 459 nanometers (blue), that may be utilized in an apparatus 100 together with light emissions from second and third light sources 115, 135 at respective emission wavelengths of 532 nanometers (green) and 630 nanometers (red). The graph 405 has circles marking emission wavelengths for the first laser 110 in ten nanometer increments, including circles 406, 407 and 408 respectively indicating 500, 530 and 600 nanometers. In this example, however, a different first laser 110 is selected, having an emission wavelength of 420 nanometers. The graph 405 is juxtaposed on examples of conventional perceptual color spaces 410, 415, 420 that may be identified by designations respectively including NTSC, DCI, and IEC. As to the conventional perceptual color spaces 410, 415, 420, the horizontal x-axis plots relative levels of stimulus (“x”) of red cone cell receptors of a human eye on an intensity scale within a range of between 0 to 0.8. Further as to the conventional perceptual color spaces 410, 415, 420, the vertical y-axis plots relative levels of stimulus (“y”) of green cone cell receptors of a human eye on an intensity scale within a range of between 0 to 0.9. The plotted perceptual color spaces 410, 415, 420 embody normalized light emissions (not themselves plotted in FIG. 4) from a first light source 110 at wavelengths within a range of between 405 nanometers to 459 nanometers having a perceptual blue color, in the same manner as discussed earlier with regard to FIG. 3. It is understood by those skilled in the art that the first, second, and third light sources 110, 115, 135 may be utilized, for example, as primes for generating a perceptual color space 410, 415, 420 in the same manner as discussed earlier with regard to FIG. 3.

For example, a laser 110 may be selected for utilization as the first light source, having an operating emission wavelength of 420 nanometers as indicated by the point 425. In the same example, lasers 115 and 135 may be selected to emit light at 532 nanometers and 630 nanometers, respectively represented by points 430 and 435. The boundary lines 440 together with a line (not shown) ending at the points 430, 435 then define a perceptual color space 445 that may be generated, as an example, utilizing lasers 110, 115, 135 having operating emission wavelengths of 420, 532 and 630 nanometers, respectively. Where the perceptual color space 445 is generated, a part 450 of the NTSC perceptual color space 410 may be excluded, for example. The part 450 of the NTSC perceptual color space 410 that may be so excluded from generation where a laser 110 is utilized having an operating emission wavelength of 420 nanometers, may represent perceptual colors that cannot be generated by combining together light emissions from the three color sources 110, 115, 135. However, the part 450 may represent a small portion of the perceptual color space 410 that cannot be generated utilizing such a laser 110 as the first color source. Likewise, small parts of the perceptual color spaces 415, 420 may be excluded from generation by utilizing the three color sources 110, 115, 135 including such a laser 110 as the first color source.

In an example, an apparatus 100 may have a color mixing light source 105 including a laser 110 having a selected operating emission wavelength of 459 nanometers or of 420 nanometers. Where, for example, the apparatus 100 is then utilized to generate a selected perceptual mixture 140 of light, the color mixing light source 105 may be unable to produce parts 355, 450 of the perceptual color spaces 310, 410 respectively. In an example, the apparatus 100 may be operated with the understanding that the parts 355, 450 representing small portions of the perceptual color spaces 310, 410 cannot be generated. For example, parts 355, 450 of the perceptual color spaces 310, 410 that may not be producible by the apparatus 100 as configured with selected lasers 110, 115, may be located near the boundary lines 345, 440 of the perceptual color spaces 310, 410. Likewise, the apparatus 100 may be operated with the understanding that analogous small parts of the perceptual color spaces 315, 320, 415, 420 cannot be generated. In an example, the controller 120 may receive color control data in a standard NTSC format at the color control data input 125. Following such an example, color control data for the parts 355, 450 may then be discarded by the apparatus 100 including lasers 110 respectively operating at 459 nanometers and 420 nanometers, for example at the color control data output 130.

As another example, the controller 120 may be configured for programming to receive color control data conforming to a first perceptual color space at the color control data input 125 and to transmit color control data conforming to a second perceptual color space at the color control data output 130. For example, the controller 120 may be configured for programming adapted to map the parts 355, 450 into the remainder of the perceptual color spaces 310, 410 respectively. As an example, such programming for mapping parts 355, 450 into the perceptual color spaces 310, 410 may execute data processing techniques including projective transformation. In a further example, the controller 120 may be configured for programming adapted to map the parts 355, 450 into nearest intersections with a perceptual color space 350, 445 that can be generated by the selected color mixing light source 105. As another example, the controller 120 may be configured for programming adapted to map the perceptual color spaces 310, 410 into perceptual color spaces 350, 445 that can be generated by the selected color mixing light source 105.

A method that includes outputting light from a first light source emitting light at one or a plurality of first light emission wavelengths of 459 nanometers or less, and outputting light from a second light source emitting light at one or a plurality of second light emission wavelengths of 470 nanometers or more, is additionally provided. The method includes forming a perceptual mixture of light having a perceptual color, the perceptual mixture including light emissions from the first and second light sources. The method may, for example, further include receiving color control data conforming to a first perceptual color space, converting the received color control data into color control data conforming to a second perceptual color space, and utilizing the color control data conforming to the second perceptual color space in controlling the light emissions from the first and second light sources.

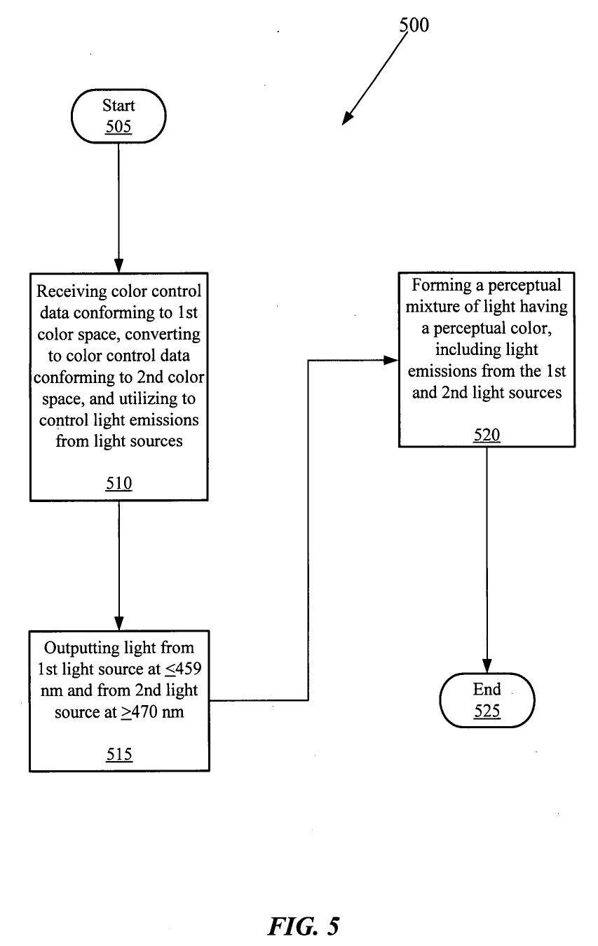

FIG. 5 is a flow chart showing an example of an implementation of a method 500. The method starts at step 505. Step 515 includes outputting light from a first light source 110 emitting light at one or a plurality of first light emission wavelengths of 459 nanometers or less, and outputting light from a second light source 115, 135 emitting light at one or a plurality of second light emission wavelengths of 470 nanometers or more. Step 520 includes forming a perceptual mixture of light 140 having a perceptual color, the perceptual mixture including light emissions from the first and second light sources 105, 115. The method may then end at step 525. In an example, step 515 may include outputting light from a third light source 135 emitting light at one or a plurality of third light emission wavelengths of 470 nanometers or more where a third wavelength is different than a second wavelength, and forming a perceptual mixture of light 140 having a perceptual color, the perceptual mixture including light emissions from the first, second and third light sources 110, 115, 135.

As another example, the method may include, at step 510, receiving color control data conforming to a first perceptual color space 310, 315, 320, 410, 415, 420, converting the received color control data into color control data conforming to a second perceptual color space 350, 445, and utilizing the color control data conforming to the second perceptual color space 350, 445 in controlling the light emissions from the first and second light sources 110, 115. Step 510 may also include, for example, utilizing the color control data conforming to the second perceptual color space 350, 445 in controlling the light emissions from a third light source 135. Receiving color control data in step 510 may, as examples, include receiving color control data conforming to a conventional perceptual color space 310, 315, 320, 410, 415, 420 identified by a designation including a member selected from the group consisting of: NTSC, DCI, and IEC.

Converting the received color control data in step 510 into color control data conforming to a second perceptual color space 350, 445 may be carried out in a selected manner. For example, a second perceptual color space 350, 445 may be empirically determined by mapping color control data for perceptual colors in all combinations of relative intensities of light that can be generated by a selected color mixing light source 105 including lasers 110, 115.

The color control database for the second perceptual color space 350, 445 may then, for example, be mapped to corresponding color control data conforming to a first perceptual color space 310, 315, 320, 410, 415, 420. The resulting database of color control data mapped to the second perceptual color space 350, 445 may then, for example, be subtracted from the first perceptual color space 310, 315, 320, 410, 415, 420. Any subset of color control data for the first perceptual color space 310, 315, 320, 410, 415, 420 remaining after the subtraction then represents a part 355, 450 of the first perceptual color space 310, 315, 320, 410, 415, 420 that cannot be generated by the color mixing light source 105. In another example, any such remaining part 355, 450 of the first perceptual color space 310, 315, 320, 410, 415, 420 may be mapped into the second perceptual color space 350, 445 to correct for the lack of capability to generate color control data for such a remainder. As an example, the second perceptual color space 350, 445 may be approximated as being constituted by the first perceptual color space 310, 315, 320, 410, 415, 420 minus the part 355, 450. Then for example, a line 360, 455 may be arbitrarily drawn from and pivot on the point 340, 435 of the first perceptual color space 310, 410 opposite the part 355, 450, to intersect through the boundary lines 345, 440 with all of the perceptual color space in the part 355, 450. Any color control data in a part 355, 450 omitted from the second perceptual color space 350, 445 may then be mapped to a nearest point in the second perceptual color space 350, 445, and then assigned to a color control data point that is on the line 360, 455 and that intersects with the boundary lines 345, 440 of the second perceptual color space 350, 445 and with the omitted color control data point to be mapped. As another example, the second perceptual color space 350, 445 may be emulated by the empirically determined color control database earlier discussed, instead of being approximated.

As a further example, the first perceptual color space 310, 315, 320, 410, 415, 420 may be compressed into the second perceptual color space 350, 445 instead of subtracting the second perceptual color space 350, 445 from the first perceptual color space 310, 315, 320, 410, 415, 420 to generate a remainder to be mapped. For example, the empirically-determined database of color control data mapped to the second perceptual color space 350, 445 may be utilized to proportionally map all possible color control data of the first perceptual color space 310, 315, 320, 410, 415, 420 into the empirically-determined database of color control data mapped to the second perceptual color space 350, 445. As an example, color control data points in the part 355, 450 may be mapped to points reaching into an interior of the second perceptual color space 350, 445. In this manner, color control data in the first perceptual color space 310, 315, 320, 410, 415, 420 at points along the line 360, 455 as fixed at a given position pivoted on the point 340, 435 may effectively be evenly compressed and mapped along the full length of the line 360, 455 in the second perceptual color space 350, 445. In another example, this compression may be carried out with the line 360, 455 unattached to the point 340, 435. As an example, the line 360, 455 may be oriented in a direction represented by an arrow 365, 460 perpendicular to a portion of the boundary lines 345, 440 that also forms a boundary of the part 355, 450, instead of pivoting on the point 340, 435. A method 500 utilizing such compression may, for example, improve contrast between perceptual colors in an image generated by a color mixing light source 105, compared with a method 500 mapping color control data from a first perceptual color space 310, 315, 320, 410, 415, 420 that cannot be generated by the apparatus 100 into nearest points in a second perceptual color space 350, 445.

It is understood by those skilled in the art that rules may be mathematically formulated for programming a suitable digital data processor to compute, store, and retrieve color control data and to carry out computations for mapping and otherwise handling color control data as discussed above.

A system is also provided, including: first color control data conforming to a first perceptual color space; second color control data conforming to a second perceptual color space; and a digital data processor configured to map the first color control data to the second color control data. In an example, the digital data processor may be configured to subtract the second perceptual color space from the first perceptual color space, and to map any remaining part of the first perceptual color space into the second perceptual color space. As another example, the digital data processor may be configured to compress the first perceptual color space into the second perceptual color space.

FIG. 6 is a schematic view showing an example of an implementation of a system 600. The system 600 may, for example, include a first database 605 of color control data conforming to a first perceptual color space, a second database 610 of color control data conforming to a second perceptual color space 350, 445, and a digital data processor 615. For example, selection of the first and second databases 605, 610 may be based on an operating architecture for the system 600. As an example, an operating architecture may include receiving color control data formatted in conformance with a conventional perceptual color space, followed by transmitting color control data transformed into a format compatible with a selected color mixing light source 105. Accordingly, the first database 605 of color control data conforming to a first perceptual color space may for example include a complete database of color control data defining a conventional NTSC, DCI, or IEC perceptual color space 310, 315, 320, 410, 415, 420. Further, the second database 610 of color control data conforming to a second perceptual color space 350, 445 may for example include a complete database of color control data that can be generated by a selected color mixing light source 105. Such a complete database may be empirically generated, for example.

The digital data processor 615 is in signal communication with the first and second databases 605, 610 as indicated by arrows 625, and is configured to map the first database into the second database. For example, the digital data processor 615 may be configured to generate, store, error-correct and access a third database 620 including color correlation data for cross-correlating the color control data in each of the first and second databases 605, 610 based on the perceptual colors corresponding with matched color control data in the databases 605, 610. In an example, the digital data processor 615 may be configured to subtract the second perceptual color space 350, 445 from the first perceptual color space 310, 315, 320, 410, 415, 420 in a manner analogous to the discussions above of such subtractions, and to then map any remaining part of the first perceptual color space 310, 315, 320, 410, 415, 420 into the second perceptual color space 350, 445, likewise in a manner analogous to the discussions above. As another example, the digital data processor 615 may be configured to compress the first perceptual color space 310, 315, 320, 410, 415, 420 into the second perceptual color space 350, 445, in a manner analogous to the compressions discussed above. It is understood by those skilled in the art that a plurality of color control data conforming to the first perceptual color space 310, 315, 320, 410, 415, 420 may be substituted for the first database 605, and that a plurality of color control data conforming to the second perceptual color space 350, 445 may be substituted for the second database 610.

A method is further provided, including: receiving color control data conforming to a first perceptual color space, and identifying the first perceptual color space; accessing color control data defining a second perceptual color space; mapping the first perceptual color space into the second perceptual color space; and converting the received color control data conforming to the first perceptual color space into color control data conforming to the second perceptual color space. The method may, for example, include subtracting the second perceptual color space from the first perceptual color space, and mapping any remaining part of the first perceptual color space into the second perceptual color space. As another example, the method may include compressing the first perceptual color space into the second perceptual color space.

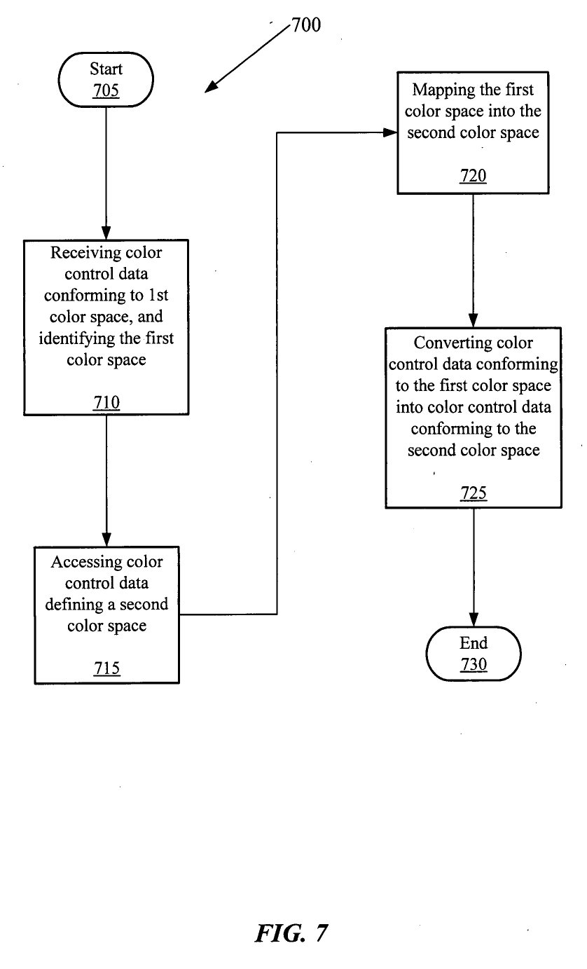

FIG. 7 is a flow chart showing an example of an implementation of a method 700. The method starts at step 705, and then step 710 includes receiving color control data conforming to a first perceptual color space, and identifying the first perceptual color space. Step 715 includes accessing color control data defining a second perceptual color space 350, 445. Mapping the first perceptual color space into the second perceptual color space 350, 445 is carried out in step 720. At step 725, the received color control data conforming to the first perceptual color space is converted into color control data conforming to the second perceptual color space 350, 445. The method may end at step 730. As an example, the color control data conforming to a first perceptual color space may be formatted in conformance with a conventional perceptual color space. The first perceptual color space may, as examples, be a conventional NTSC, DCI, or IEC perceptual color space 310, 315, 320, 410, 415, 420. Accordingly, step 710 may include, for example, receiving color control data conforming to a conventional NTSC perceptual color space 310, 410, the color control data representing an image captured by a video camera in NTSC format.

Accessing color control data defining a second perceptual color space 350, 445 in step 715 may include, for example, accessing a complete database of color control data that can be generated by a selected color mixing light source 105. In this manner, for example, the method 700 may be utilized to generate color control data for operating a color mixing light source 105 that cannot generate all combinations of color control data constituting the first perceptual color space 310, 315, 320, 410, 415, 420. Mapping the first perceptual color space 310, 315, 320, 410, 415, 420 into the second perceptual color space 350, 445 in step 720 may, for example, include generating, storing, error-correcting, and accessing color correlation data. As an example, color control data conforming to the first perceptual color space 310, 315, 320, 410, 415, 420 may be cross-correlated with color control data conforming to the second perceptual color space 350, 445, based on matched perceptual colors.

Converting of the received color control data conforming to the first perceptual color space 310, 315, 320, 410, 415, 420 at step 725 into color control data conforming to the second perceptual color space 350, 445 may include, for example, subtracting the second perceptual color space 350, 445 from the first perceptual color space 310, 315, 320, 410, 415, 420 in a manner analogous to the discussions above of such subtractions. Any remaining part of the first perceptual color space 310, 315, 320, 410, 415, 420 may then, as an example, be mapped into the second perceptual color space 350, 445 in a manner analogous to the discussions above. Converting of the received color control data conforming to the first perceptual color space 310, 315, 320, 410, 415, 420 at step 725 into color control data conforming to the second perceptual color space 350, 445 may alternatively or additionally include, for example, compressing the first perceptual color space 310, 315, 320, 410, 415, 420 into the second perceptual color space 350, 445, in a manner analogous to the discussions above.

The apparatus 100 may, for example, be utilized as a source of controlled, selectable perceptual mixtures of light 140 having selectable perceptual colors, for utilization in diverse end-use applications and as integrated with diverse apparatus adapted to process and to display such perceptual mixtures of light 140. As examples, the apparatus 100 may be utilized as a source for image projection apparatus of selectable perceptual mixtures of light 140 having selectable perceptual colors. Such image projection apparatus may include, as examples, arrays of micro-electronic-mechanical systems (“MEMS”) including mirrors that may be tiltable, rotatable, translatable, or otherwise redirectable. Examples of end-use devices that may incorporate such MEMS devices or other devices that utilize selectable perceptual mixtures of light 140 may include media players, cellular communicators, desktop and portable computer monitors, personal digital assistants, satellite positioning system (“SPS”) devices, and microprojectors. Likewise, the systems 600, methods 500, and methods 700 may be utilized in diverse end-use applications for such perceptual mixtures of light 140.

The apparatus, systems and methods 100, 500, 600, 700 may further be utilized together with apparatus, systems and methods disclosed in U.S. patent application Ser. No. ______, filed concurrently herewith by Vladimir A. Aksyuk, Robert E. Frahm, Omar D. Lopez, and Roland Ryf, entitled “HOLOGRAPHIC MEMS OPERATED OPTICAL PROJECTORS”, docket no. Aksyuk 45-10-12-14. The apparatus, systems and methods 100, 500, 600, 700 may additionally be utilized together with apparatus, systems and methods disclosed in U.S. patent application Ser. No. ______, filed concurrently herewith by Randy C. Giles, Omar D. Lopez, and Roland Ryf, entitled “DIRECT OPTICAL IMAGE PROJECTORS”, docket no. Giles 81-13-15. In addition, U.S. patent application Ser. No. ______, filed concurrently herewith by Vladimir A. Aksyuk, Randy C. Giles, Omar D. Lopez, and Roland Ryf, entitled “SPECKLE REDUCTION IN LASER-PROJECTOR IMAGES”, docket no. Aksyuk 46-80-11-13, discloses techniques for addressing destructive interference at edges of light pixels having perceptual colors as projected utilizing color mixing light sources. Such techniques for addressing destructive interference may, for example, be utilized in connection with the apparatus 100, systems 600, and methods 500, 700. The entireties of all of these concurrently-filed patent applications are incorporated into this patent application by reference.

While the foregoing description refers in some instances to the apparatus 100 and system 600 shown in FIGS. 1 and 6, it is appreciated that the subject matter is not limited to these structures, nor to the structures discussed in the specification. Other shapes and configurations of apparatus and systems may be fabricated. Likewise, the methods 500, 700 as shown in FIGS. 5 and 7 and as disclosed in the specification may be performed respectively utilizing any selected apparatus 100 or system 600. Further, it is understood by those skilled in the art that the methods 500, 700 may include additional steps and modifications of the indicated steps.

Moreover, it will be understood that the foregoing description of numerous examples has been presented for purposes of illustration and description. This description is not exhaustive and does not limit the claimed invention to the precise forms disclosed. Modifications and variations are possible in light of the above description or may be acquired from practicing the invention. The claims and their equivalents define the scope of the invention.

What is claimed is:

1. An apparatus, comprising:
a color mixing light source having a first laser configured to lase at one or a plurality of light emission wavelengths of 459 nanometers or less and a second laser configured to lase at one or a plurality of light emission wavelengths of 470 nanometers or more; and
a controller having a color control data input, and a color control data output configured to cause the color mixing light source to generate a perceptual mixture of light having a perceptual color, the perceptual mixture including light emissions from the first and second light sources.

2. The apparatus of claim 1, where the first laser is configured to lase at one or a plurality of light emission wavelengths within a range of between 405 nanometers to 459 nanometers.

3. The apparatus of claim 1, where the first laser is configured to lase at one or a plurality of light emission wavelengths within a range of between 420 nanometers to 459 nanometers.

4. The apparatus of claim 1, where the first laser is configured to lase at one or a plurality of light emission wavelengths within a range of between 420 nanometers to 445 nanometers.

5. The apparatus of claim 1, where the first laser includes a Group III-nitride laser.

6. The apparatus of claim 1, where the first laser includes a wavelength-converted infrared laser.

7. The apparatus of claim 1, where the color mixing light source includes a third laser configured to lase at one or a plurality of light emission wavelengths of 470 nanometers or more and each of the first, second and third lasers is configured to lase at different wavelengths, the color mixing light source forming a perceptual mixture of light having a perceptual color, the perceptual mixture including light emissions from the first, second and third light sources.

8. The apparatus of claim 1, where the controller is configured to receive color control data conforming to a first perceptual color space at the color control data input and to transmit color control data conforming to a second perceptual color space at the color control data output.

9. The apparatus of claim 8, where the first perceptual color space is a conventional perceptual color space identified by a designation including a member selected from the group consisting of: National Television System Committee (“NTSC”), Digital Cinema Initiatives (“DCI”), and International Electro-technical Commission (“IEC”).

10. A method, comprising:
outputting light from a first light source emitting light at one or a plurality of first light emission wavelengths of 459 nanometers or less, and outputting light from a second light source emitting light at one or a plurality of second light emission wavelengths of 470 nanometers or more; and
forming a perceptual mixture of light having a perceptual color, the perceptual mixture including light emissions from the first and second light sources.

11. The method of claim 10, including outputting light from a third light source emitting light at one or a plurality of third light emission wavelengths of 470 nanometers or more where a third wavelength is different than a second wavelength, and forming a perceptual mixture of light having a perceptual color, the perceptual mixture including light emissions from the first, second and third light sources.

12. The method of claim 10, including receiving color control data conforming to a first perceptual color space, converting the received color control data into color control data conforming to a second perceptual color space, and utilizing the color control data conforming to the second perceptual color space in controlling the light emissions from the first and second light sources.

13. The method of claim 12, where receiving color control data includes receiving color control data conforming to a conventional perceptual color space identified by a designation including a member selected from the group consisting of: National Television System Committee (“NTSC”), Digital Cinema Initiatives (“DCI”), and International Electro-technical Commission (“IEC”).

14. A system, including:
first color control data conforming to a first perceptual color space;
second color control data conforming to a second perceptual color space; and
a digital data processor configured to map the first color control data to the second color control data.

15. The system of claim 14, where the digital data processor is configured to subtract the second perceptual color space from the first perceptual color space, and to map any remaining part of the first perceptual color space into the second perceptual color space.

16. The system of claim 14, where the digital data processor is configured to compress the first perceptual color space into the second perceptual color space.

17. A method, including:
receiving color control data conforming to a first perceptual color space, and identifying the first perceptual color space;
accessing color control data defining a second perceptual color space;
mapping the first perceptual color space into the second perceptual color space; and
converting the received color control data conforming to the first perceptual color space into color control data conforming to the second perceptual color space.

18. The method of claim 17, including subtracting the second perceptual color space from the first perceptual color space, and mapping any remaining part of the first perceptual color space into the second perceptual color space.

19. The method of claim 17, including compressing the first perceptual color space into the second perceptual color space.

20. The method of claim 17, where accessing color control data defining a second perceptual color space includes accessing a second perceptual color space generated by mapping perceptual colors of perceptual mixtures of light emissions from a color mixing light source having a first laser configured to lase at one or a plurality of light emission wavelengths of 459 nanometers or less and a second laser configured to lase at one or a plurality of light emission wavelengths of 470 nanometers or more.
